(19) United States
(12) Patent Application Publication
(10) Pub. No.: US 2012/0003616 A1
(43) Pub. Date: Jan. 5, 2012

(54) Educational Ruler

(76) Inventor: Alexandro Ricardo Frau, Johannesburg (ZA)

(21) Appl. No.: 13/201,335

(22) PCT Filed: Feb. 12, 2010
(86) PCT No.: PCT/ZA2010/000007

§ 371 Date: Sep. 23, 2011

(30) Foreign Application Priority Data
Feb. 13, 2009 (ZA) 2009/01253

(51) Int. Cl. G09B 17/00

(52) U.S. Cl. 434/178

(57) ABSTRACT

An educational ruler which includes a body and a sliding member, the sliding member movable to define an isolation window to isolate particular words or phrases for educational purposes

### BACKGROUND TO THE INVENTION

This invention relates to an educational ruler and more particularly relates to an educational ruler utilised for facilitating and increasing reading accuracy and better word recognition.

Various types of rulers exist of which the most commonly known or utilised in the educational system for measuring purposes and facilitating drawing of straight lines.

Most rulers are manufactured from either a plastics material, alternatively a steel or wooden material. Normally, measurement units are depicted one side of the ruler enabling a user to utilise such a ruler for measuring purposes. The measuring units may vary, however in most instances the measuring units are either centimetres, millimetres or inches.

One of the most important skills to be learned by scholars is reading. Especially young scholars, up until the age of approximately 7 years, have the capability of memorising words and phrases without the need of reading it. In many instances, the presence of either a symbol or picture enables the scholar to regurgitate the sentence word for word without reading or recognising any of the words present. For example, one may change the entire sentence but have the same symbol present, and a scholar will regurgitate the entire sentence as previously read.

This is a major concern as scholars do not properly develop their reading skills and recognition of words. Many methods have been followed in order to properly teach scholars to recognise various words. For example, reading cards are one of the most commonly known methods to develop and better reading skills of the scholar as well as increasing the recognition capability of words and phrases. However, a problem generally associated with this method is that it is time-consuming and a teacher is normally confined to the words depicted on the reading cards.

Another method normally utilised is the blanking out of various words in an attempt to isolate a particular word to be trained to the scholar. This is either done by blocking out the excess words with one's hands alternatively with paper. However, it is apparent that this method is frustrating as more than one paper is required and using one's hands decreases visibility of the word especially when reading small print.

It is an object of the current invention to provide an educational ruler and a method which will at least partially alleviate some of the aforementioned problems.

### SUMMARY OF THE INVENTION

The invention provides for an educational ruler which includes a body and at least one sliding member, movable between a first position wherein the sliding member conforms to the body of the educational ruler, and a second position wherein the sliding member is extended to define an isolation window.

The invention further provides for the sliding member to engage with the body by means of a slidable tongue and groove formation, so that the sliding member and the body are coplanar and slidable relatively away from each other.

The body of the educational ruler may include at least one gripping member, which gripping member may consist of a plurality of ribs to facilitate easy gripping, alternatively the gripping member may consist of a single protrusion which extends upwardly away from the body.

Furthermore, educational material may be depicted on one side of the body and more particularly may include measurements to facilitate measuring of units. The body of the educational ruler may yet further include advertising material which may be depicted on at least one side of the body.

The sliding member may further include at least one gripping member which gripping member may consist of a plurality of ribs to facilitate easy gripping of the sliding member, alternatively the gripping member may consist of a single protrusion which extends upwardly away from the sliding member.

The invention further extends to a method of education which includes the steps of utilising an educational ruler as hereinbefore described to isolate particular words or phrases by moving the sliding member of the educational ruler between its first position and its second position, defining an isolation window in which a word or phrase may be isolated.

### BRIEF DESCRIPTION OF THE DRAWINGS

The invention is now further described by way of example with reference to the accompanying drawing wherein:

FIG. 1 is a perspective view of an educational ruler according to the invention in a first position;

FIG. 2 is a perspective view of the educational ruler in FIG. 1 in a second position; and

FIG. 3 is plan view of the educational ruler in use.

### DESCRIPTION OF PREFERRED EMBODIMENTS

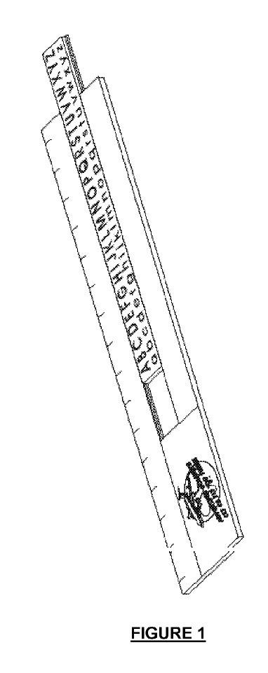

FIGS. 1 to 3 illustrates an educational ruler 10 which includes a body 12 and at least one sliding member 14 which is slidably engaged with the body 12 by means of a tongue and groove formation 16.

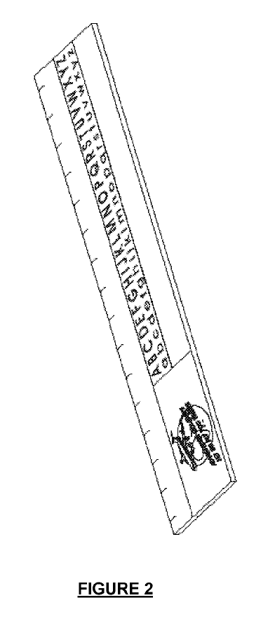

The sliding member 14 is movable between a first position wherein the sliding member 14 conforms with the body 12 having the appearance of a conventional ruler as is more clearly illustrated in FIG. 2, and a second position in which the sliding member 14 is slightly extended away from the body 12 to define an isolation window 18 (FIG. 1).

Gripping members 28 is also provided on one side of the body 12, to facilitate easy gripping of the ruler 10. Preferably, the sliding member 14 also includes gripping members (not shown) to facilitate easy gripping of the sliding member when moving the sliding member 14 between its first and second positions. The gripping members 28 consists of a plurality of ribs, alternatively consists of at least one protrusion (not shown) extending upwardly away from the body 12 and sliding member 14 respectively, to enable a user to grip the body 12 or sliding member 14 between his or her thumb and forefinger.

The sliding member 14 includes alphanumerical symbols 20 depicted on at least one side of the sliding member 14. The body 12 further includes markings 22 similar to that of a conventional type ruler which is utilised for measuring purposes and is calibrated in various scientific units such as centimetres, millimetres alternatively inches.

Advertising space 24 is also provided on the body 12 enabling a sponsor to depict its logo thereon.

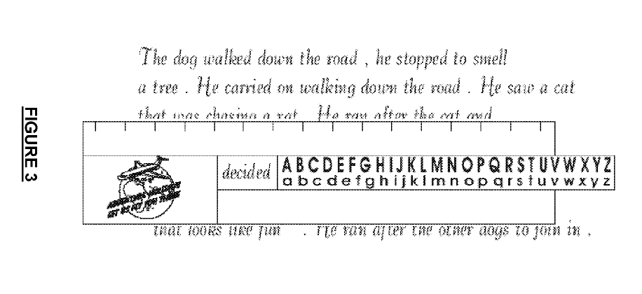

FIG. 3 illustrates the educational ruler 10 in use. The ruler 10 is positioned over a paragraph 26. The sliding member 14 is moved relatively away from the body 12 to define the isolation window 18, isolating a particular word or phrase 26. In this particular example the word “decided” has been isolated.

It will be appreciated by a person skilled in the art that the educational ruler 10 enables a student to be taught to read and identify particular words. The alphanumerical symbols 20 depicted on the sliding member 14 enables a student to more clearly identify particular letters and recognised same in the context of a word or phrase.

Furthermore, the body and sliding member may be manufactured from any suitable material such as a plastics, wooden or steel material.

It will further be appreciated that by sliding the sliding member 14 relative to the body 12, various words or phrases can be isolated for training purposes. The body 12 of the educational ruler 10, blocks out any excess words and hence isolates only the words and/or phrases to be taught to the student. Furthermore, no reading cards are required and one is not confined to particular words, but can taught a student recognition of a particular word or phrase that is present in any type of reading material.

1. An educational ruler which includes a body and at least one sliding member, the sliding member movable between a first position wherein the sliding member conforms to the body of the educational ruler, and a second position wherein the sliding member is extended to define an isolation window.

2. An educational ruler as claimed in claim 1, wherein the sliding member is engaged with the body by means of a slidable tongue and groove formation.

3. An educational ruler as claimed in claim 1, wherein the sliding member and body is coplanar and slidable relative away from each other to define the isolation window.

4. An educational ruler as claimed in claim 1, wherein the body includes at least one gripping member.

5. An educational ruler as claimed in claim 4, wherein the gripping member consists of a plurality of ribs to facilitate easy gripping.

6. An educational ruler as claimed in claim 1, wherein educational material is depicted on one side of the body.

7. An educational ruler as claimed in claim 6, wherein the educational material is measurements to facilitate measuring of units.

8. An educational ruler as claimed in claim 6, wherein the educational material is of alphanumerical nature and includes the alphabet in lower as well as upper case to facilitate easy recognition of alphanumerical symbols.

9. An educational ruler as claimed in claim 1, wherein the body includes advertising material which is depicted on at least one side of the body.

10. An educational ruler as claimed claim 1, wherein the sliding member includes at least one gripping member.

11. An educational ruler as claimed in claim 10, wherein the gripping member consists of a plurality of ribs to facilitate easy gripping of the sliding member.

12. An educational ruler as claimed in claim 10, wherein the gripping member consists of at least one protrusion which extends upwardly away from the sliding member.

13. An educational ruler as claimed in claim 1, wherein the body and sliding members is manufacture from any suitable material, but preferably is manufactured from a plastics, wooden or a steel material.

14. A method of education which includes the steps of utilizing an educational ruler as claimed in claim 1 to isolate particular words or phrases by moving the sliding member of the educational ruler between its first position and its second position, defining and isolation window in which a word or phrase may be isolated.

15. (canceled)
